(19) United States
(12) Patent Application Publication
(10) Pub. No.: US 2026/0241801 A1
(43) Pub. Date: Aug. 20, 2026

(54) ELECTRIC VEHICLE WITH RENEWABLE POWER SOURCE

(71) Applicant: Chikezie Ottah, Dallas, GA (US)

(72) Inventor: Chikezie Ottah, Dallas, GA (US)

(21) Appl. No.: 19/647,238

(22) Filed: Apr. 14, 2026

Related U.S. Application Data
(63) Continuation-in-part of application No. 15/530,963, filed on Mar. 29, 2017, now abandoned.
(60) Provisional application No. 62/390,732, filed on Apr. 7, 2016.

(51) Int. Cl. B60L 8/00

(52) U.S. Cl. CPC B60L 8/003; B60L 8/006; B60L 2200/26; B60L 2200/32

(57) ABSTRACT

A renewable electric vehicle is provided that is powered by a renewable power source. The renewable electric vehicle has an adjustable and modifiable front portion, side portions, back portion, and roof portion. Using clips and adjustable holes in a body of the electric vehicle, spacing between the portions can be adjusted. The electric vehicle may be an automobile, a ship or a train. The renewable power source may be provided by a solar array, a wind turbine system or a charging station.

### CROSS REFERENCE TO RELATED APPLICATIONS

This application is a continuation-in-part (CIP) of U.S. application Ser. No. 15/530,963, filed on Mar. 29, 2017, which claims priority from U.S. Provisional Application No. 62/390,732, filed Apr. 7, 2016.

### FIELD OF THE INVENTION

The present invention generally relates to a new renewable electric vehicle. More specifically, the present invention relates to a new renewable electric vehicles assembly, and the new renewable vehicle is modified from jeep (trademark) and compact vehicles to industrial vehicles.

### BACKGROUND

The world is going carbon neutral to avoid global warming, the science community has warned if we do not start better practices to reduce pollution there will be no revise in global warming, the science warning have many industrial sectors to reduce emitting of carbon dioxide released into the atmosphere, all automobile industries rose to the challenge, the automobile industries are now introducing a brand of electric car or vehicles, a good effort to reduce carbon dioxide on earth.

As the science community has sounded the alarm of eminent danger to the earth if the world does not achieve a carbon neutral environment, a new electric vehicle or cars may be introduced which run or drive on a clean or renewable electricity.

The whole world, especially the developing countries suffer from adequate source of electricity, the advantage of renewable electricity, renewable electricity have an abundant source of clean power, it can generate over 1000 watts of electricity, enough electric to power a train or ship with electric motor, while range for conventional electric (non-renewable electric vehicle) vehicle are limited, another deficiencies of conventional electric vehicles are the main source of the energy is not continues supply, and the conventional electric cars use much energy on highways but the renewable electric vehicles can switch to on broad main charger or recharger, range for conventional electric vehicle reduce during hauling or in speed, and the cost to maintain and own a conventional electric vehicle is too high to affect the desirable carbon neutral to bolt the global warming.

### SUMMARY OF INVENTION

The present invention is a new automated electric vehicle assembly, the new vehicle is a renewable power electric vehicle, the only electric vehicle assembly with an abundant renewable supply of electric that power electric vehicles, no other electric vehicle electric car, air plan, pickup truck, bus, train, van, jeep (trademark), or edanlrvG1J, ship vehicles have unlimited power supply.

The alternative clean renewable energy may be generated by an electric source comprising adjustable rotatable wheels and/or vanes rated to produce electricity. Clean, non-emitting electricity may be provided to the electric vehicle to charge the battery or electric battery system of the electric vehicle.

The solar array or wind turbine may be carried by a ship for renewal power charging while driving, or other alternative renewable power supply, like mobile repair and or recharging unit to ships or trains along water or rail terrain. The only electric vehicles that can separably incorporate an adjustable renewable power source for continue charging of electric vehicle or and battery equipment while the electric vehicle is in driving, due to the incorporated and mounted renewable electric energy source(s) this new electric vehicle have unlimited range to other electric vehicles, new electric vehicles have good performance than other electric vehicles during rain, climbing a hill, hulling, or driving interstate.

The new electric mobile vehicle comprises an attached mobile caption (overhead equipment caption renewable electric system) clean solar array. The adjustable mounted solar array and equipment adjustable charger may continue charging from the renewable electric of the new electric vehicle motor system, or the electric vehicle system, the vehicle concentrically interconnecting the new electric motor, transmission, connecting the electric vehicle coolant (or radiator system), interconnecting the module devices connecting semiconductor, conductor, fluid and windshield and wiper, head light, wheels, suspensions, dash board, break systems, steering gear, seat technology, battery system and all other motor mounts of the renewable clean electric vehicle concentric electric vehicle network to drive the new renewable electric vehicle.

The renewable electric vehicle supporting structure includes an adjustable shell configuration and trim modification, adaptable to separably interconnect front portion of motor mount members of the vehicle with a back portion, side portions and a roof portion (such as a sunroof) of the vehicle. These portions have a set of modules, clips, and holes that are modifiable, or adjustable open holes and clips around the shell configuration. The trim or motor mount members are used to mount the renewable electric vehicle interconnecting parts internally and or externally, or members in the cooperating sides, base, or roof holes and clips outside the vehicle members. The renewable electric vehicle assembly may be used to fix the electric vehicle parts by a (drill) connector. The trim is adjustably fixed along the sides, front portion or back portion with clips.

Alternatively, a body configuration and trim comprise an adaptable new clean electric power automated electric vehicle motor mount and trim configuration, (which may be manual) including an adjustable front portion. The front portion members may cover an electric vehicle motor or electric engine, and a transmission system, a coolant unit, and a dashboard. The shell configuration may be formed inside the body and trim. A front member may be modified to incorporate with a body configuration mount next to electric vehicle side portions, and side portion members, separately and adjustably mounted on the renewable power vehicle body configuration sides. A pair of vehicle side portions and front side members may be coupled to establish an adjustable space relation between the vehicle side portions and the front side portion. Further, back portion members may be mounted on a back portion of the electric vehicle body, whereby the back portion members clip the back portion to hole members. In addition, the back side portions are connected to the front side portions such that a space relationship between the front side and back side portions is established. A roof portion is adjustably mounted on the vehicle named structures for an inside shell and/or an outside electric vehicle shell. The electric vehicle further incorporates an adjustable solar array or an adjustable wind turbine power system. The renewable power enables the motor, the transmission system, the coolant unit, the dashboard, the light, automated or manual gear system, charge and rechargeable battery for an alternate uses or separate use, or combination of recharging the battery o as it been used, others, the function of remote, manual or automated windows or doors, trunk, glass windows, windshield wiper, outside or inside lights.

Further, modification of these parts is necessary for the renewable vehicle to be capable of traversing for terrain used for paved or unpaved vehicles. The chassis, wheels, rails, suspensions, and tires of the vehicles may be adjusted and/or modified. The renewable electric vehicle assembly may be a passenger car, an industrial vehicle, other special vehicle, minivan, jeep (trademark), wagon, small vehicle, etc. The vehicle may be available in developing countries, at rural or urban locations with reduced operating costs and global warming.

### BRIEF DESCRIPTION OF SEVERAL VIEWS OF THE DRAWINGS

FIG. 1 shows an electric vehicle harnessing clean and abundant power from solar array equipment according to one embodiment of present invention.

FIG. 2 shows a ship powered by an adjustable solar array and having a battery being charged by a charging station according to one embodiment of present invention.

FIG. 3 shows an electric vehicle with front, back and side portions and a roof portion for which spacing can be adjusted according to one embodiment of the present invention.

FIG. 4 is a train powered by an adjustable solar array and having a battery being charged by a charging station according to one embodiment of present invention.

FIG. 5 is an elevated view of a renewable electric vehicle according to one embodiment of present invention.

FIG. 6 is an elevated view of a hybrid electric vehicle being powered by electric power and/or fuel (e.g., gasoline) according to one embodiment of present invention.

FIG. 7 is an elevated view of an electric vehicle capable of flying (e.g., an airplane) according to one embodiment of present invention.

### DETAILED DESCRIPTION

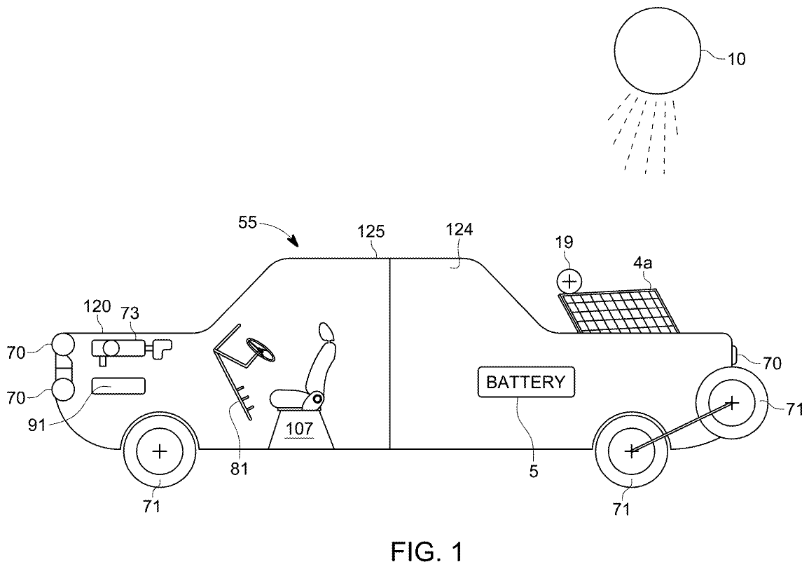

FIG. 1 shows an electric vehicle 55 configured according to one embodiment of the present invention. The electric vehicle 55 includes a battery (or battery system) 5 that is charged by a renewable energy source. In this embodiment, the renewable energy source may be a solar array 4a which receives sunlight from a light source, such as the sun 10, and generates clean, non-emitting electricity 19. The solar array 4a may be adjustably attached to the rear side of the electric vehicle 55. The solar array 4a charges battery 5 to provide power to a motor 73 of the electric vehicle 55. Preferably, the solar array 4a is adapted for continued charging of the battery 5, while the electric vehicle 55 is in motion, driving, standing, or parked.

The electric vehicle 55 further includes a transmission system 91, lights 70, wheels 71, a brake system 81, one or more seats 107, a front portion 120, a pair of side portions 124, and a roof 125.

Alternatively, clean, non-emitting electricity 19 may be provided by wheels 71 or a wind turbine power system (not shown). The renewable power source may be a manual type or a machine type.

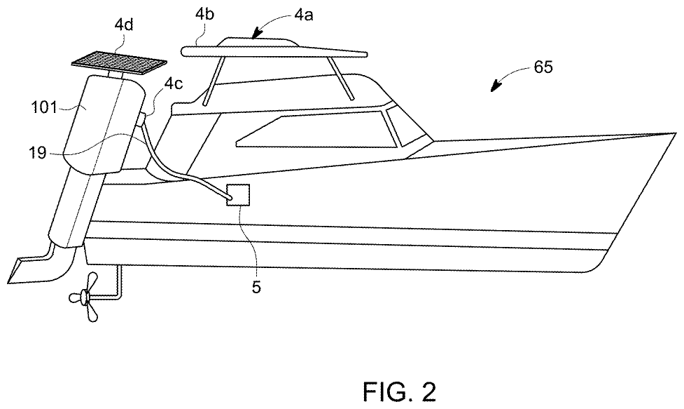

FIG. 2 shows a ship 65 configured according to another embodiment of the present invention. In this embodiment, the electric vehicle 65 is a ship including a solar array 4a for charging the battery 5 with clean, non-emitting electricity 19. Another option is to use a separate mobile charging station 101 to charge the battery 5.

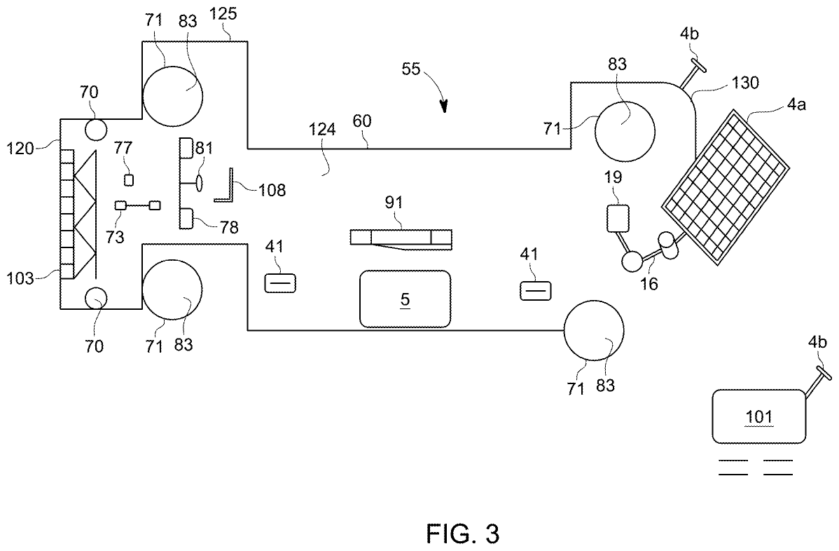

As shown in FIG. 3, the electric vehicle 55 may be equipped with enough electricity 19 to deal with the terrain on which the electric vehicle 55 uses. The electric vehicle 55 may further include electrical elements such as a transmitter, modules, conductors and equipment alternatives for continue charging, or modified dwelling charging, or the separate mobile charging stations 101 charging the battery 5 to supply power to the electric vehicle to drive on the terrain. The wheels 71, the suspension 83, or others may allow adequate supply of electricity to operate the electric vehicle 55 on a paved or unpaved terrain. For example. the adjustable electric equipment or the transmitter of the ranger of the electric current from the solar array 4a of solar, wind, water, electric or manual wind turbine power system 4b, other renewable electric sources may rise and conserve electricity including, during driving up the hill, pulling another disabled vehicle, during fish hauling, unlimited use of heating and the coolant unit 103, during training, and other terrain. The renewable power supply may provide 1000 watts of electric power for the electric vehicle 55, both for industrial vehicles, or personal electric vehicles traveling on paved or unpaved terrain. The sources of clean electric power supply or renewable power′ is abundant and cheap, renewable energy application to drive the vehicle also reduce global warming.

The electric vehicle includes an adjustable shell configuration and trim modification, adaptable to separably interconnecting the front portion 120 and side portions 124, and a back portion 130 of a supporting structure 60. The back portion 130 of the supporting structure 60 may include a horizontal elongated sheet(s) of board. The sheets of the board may include extra motor mounts and adjustable trim, an adjustable wheels 71, suspensions 83, the incorporated extra horizontal sheet of board arid trim may be separable adapted to a modified box members, like the sides portions 124, design to incorporate and interconnect to renewable power from the electric vehicle 55 for the {computer) functioning of door 41, windows 45, keys and starter, roof 125, enable windshield wipers 77, enable lights 70, enable seat technology 108, dash board 88, and the brake system 81. Further, power may be provided to the coolant unit 103, engine fan, air, and heating elements, incorporated into the electric vehicle 55 to enable a better performance of the electric vehicle 55. Members in the cooperating side portions 120, 124, 125 and 130 use clips 16 to interconnect and adjust spacing therebetween.

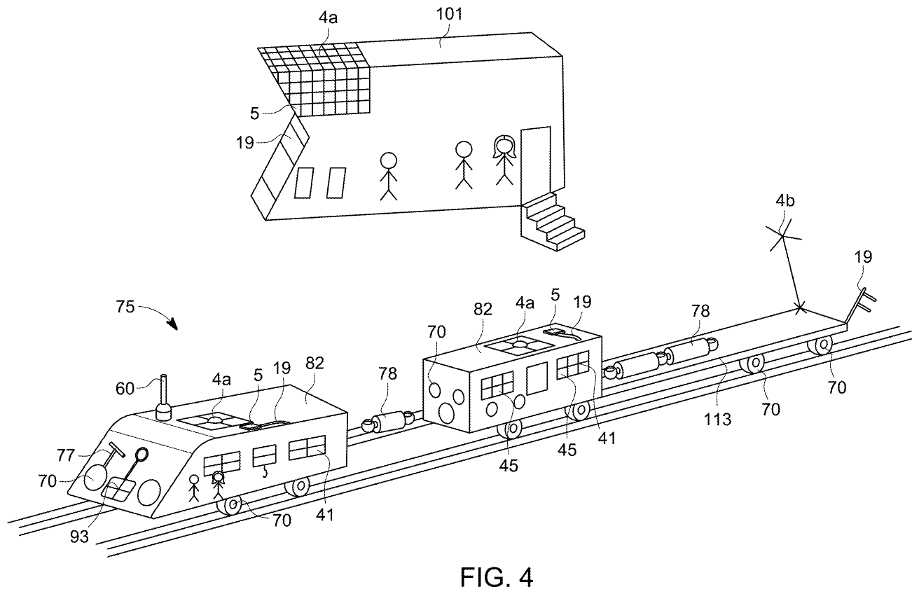

FIG. 4. illustrates a train 75 traveling on track 113 configured according to another embodiment of the present invention. The train 75 comprises a supporting structure 60 including an adjustable, shell configuration and trim modification, adaptable to separably interconnect the front portion 120 of the motor mount members, and a connecting portion or parts of the back portion 130, a pair of side portions 124, the part of the base motor mount members, and adaptable to connect the roof portion 125. The portions have a set of modules, the clips 16, and holes that are modifiable, or adjustable open holes and the clips 16 around the shell configuration, the trim or motor mount members to corporate with mounting the renewable vehicle, interconnecting parts internally and or externally, or members in the cooperating side portions 124, vehicle base, or holes and the clips 16 outside or inside the vehicle members. The renewable electric vehicle 55 assembly can fix the electric vehicle parts by a (drill, or tool) connector means.

The renewable vehicle described above may be automated or have features of automated and manual features incorporated into the electric vehicle, and the transmission system 91. The modification required for the renewable new electric vehicle would be apparent to those skilled in the art, whereby a modified tool system, robotic hoe may be mounted on the open horizontal surface of the new vehicle platform, in some acceptable way the electric vehicle 55 may track differently than other vehicle, that is the spacing between the right and left front wheels 71 and rear wheels 71 or and the suspension 83 are different than of actual tractor. In the modified tools, a robotic hoe may perform agricultural tasks, whereby a preferable power source will be renewable electricity.

A body mount horizontal sheet of board and trim may be adapted to adjust the portions 120, 124, 125 and 130. The electric vehicle 55 charges the battery 5 to power the door 41, the windows 45, the key and starter, the windshield wipers 77, the lights 70, the seat technology 81, the dashboard 88, the steeling 111, breaks system 81, the adjustable solar array 4a, and the adjustable wind turbine power system 4b, others corporately interconnect or transmit power into the electric vehicle 55 motor 73 and or batteries, the modules or the like interconnect the power to transmission system 91 to enable the electric vehicle 55 to drive while the electric vehicle is charging, or may be automatically controlled. Further, the power is provided to the coolant unit 103, motor fan, air, and heating elements, incorporated into the electric vehicle 55 to enable a better performance of the electric vehicle 55.

The renewable vehicle described above may be automated or may include an adjustable feature of automated and manual features incorporated into the electric vehicle, and a unitary body mount and trim members. The modification required for the renewable new electric vehicle would be apparent to those skilled in the art, that the vehicle jeep (trademark) and likes may be driven in a paved and or unpaved terrain.

The renewable vehicle comprises attached renewable power supply members, the clip 16, transmission systems 91, interconnecting the electric motor members, interconnecting transmission and other power network member to adjustably attach to cooperating renewable power members mounted atop the vehicle, or corporate with dwelling renewable power supply station, the above mentioned renewable power supply sources enable the vehicle motor (new engine non combustive), the power separably connects to electric power network, like modules interconnect to the vehicle transmission, the power enables design to incorporate and interconnect to renewable power from the electric vehicle modules for the (computer) functioning of door 41, windows 45, key, modifiable spark plug, roof, windshield wipers 77 on top of the wind shield, lights 70, seat technology 108, dashboard 88, steeling 111, breaks system 81, the adjustable solar array 4a, or and the adjustable wind turbine power system 4b, others corporately interconnect or transmit power into the motor 73 or batteries, the modules or the like interconnect the power to transmission and members to enable the electric vehicle to drive while transmission is automated or stick and shift, further the electric vehicle power network or module interconnected to the coolant unit 103, fan, air, and heating elements, spark plugs incorporated into the electric vehicle to enable a better performance of the electric vehicle 55.

A new electric mobile vehicle is provided with connectors, interconnectors, clips and/or a clip bodv in order to mount, install, fix, adjust, and/or modify position in order to fasten portions of the vehicle.

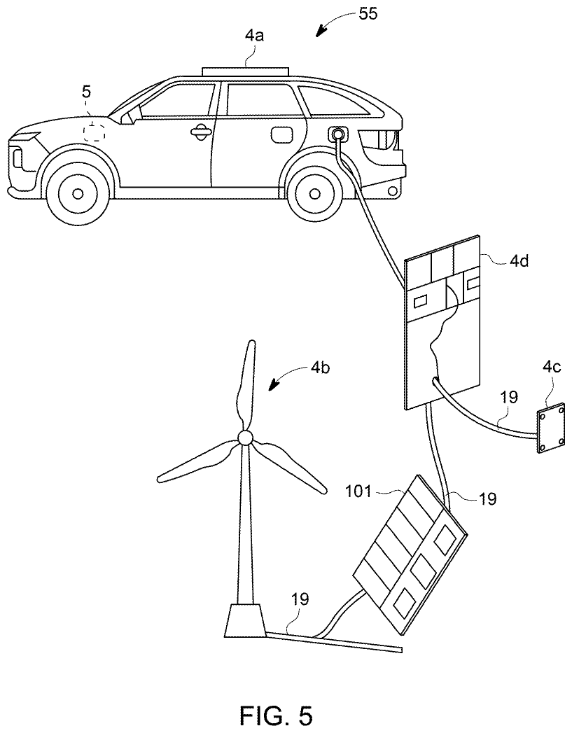

FIG. 5 is an elevated view of the electric vehicle 55 configured to be charged by electric poser a wind turbine power system 4b and/or a mobile charging station 101. Alternatively, a ground electric power base, e.g., hydroelectricity (sea base, pole power), may comprise adjustable mounted solar power and connectors, adjustable turbines and vanes and adapters, adjustable hydroelectric and land base power stations, in order to power electric vehicles recharging panels and vehicles connecting portable devices. The telescopic arrangements concentrate interconnecting the electric vehicle electronic media devices (digital signals) for self drive vehicles protocols, may be A/l ready. Examples of wave base driving vehicle protocols may include electronic devices to vehicle protocols, technology to automate vehicle protocols, electric vehicle to road sign protocols, building signal to electric vehicles protocol and electric vehicle and people's signal protocols.

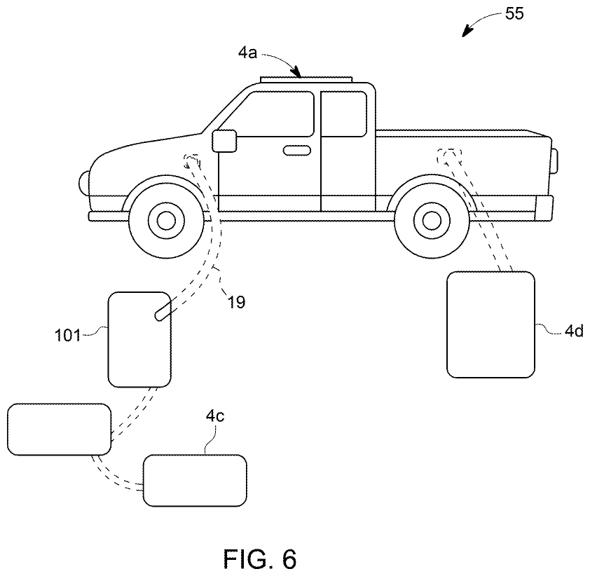

FIG. 6 is an elevated view of a hybrid electric vehicle being powered by electric power and/or fuel (e.g., gasoline). The renewable power sources can be externally and/or internally coupled to the electric vehicle. The electric vehicle can be configured to swap out one renewable energy power source for another or a combination (e.g., to transition from wind to solar energy, from battery to gasoline). The renewable energy power source further functions as a panel mount on ground base the charging station (e.g., to provide an electrical charge to an internal or external electrical device). The electronics are conductively coupled to the battery. The electronics can include electrical components and/or sensors for a steering system, climate control system, braking system, communications system, self-driving (i.e., autonomous control) system, and/or radio navigation system (e.g., global positioning system (GPS)). The electric vehicle may comprise an autonomous driving vehicle with a passenger.

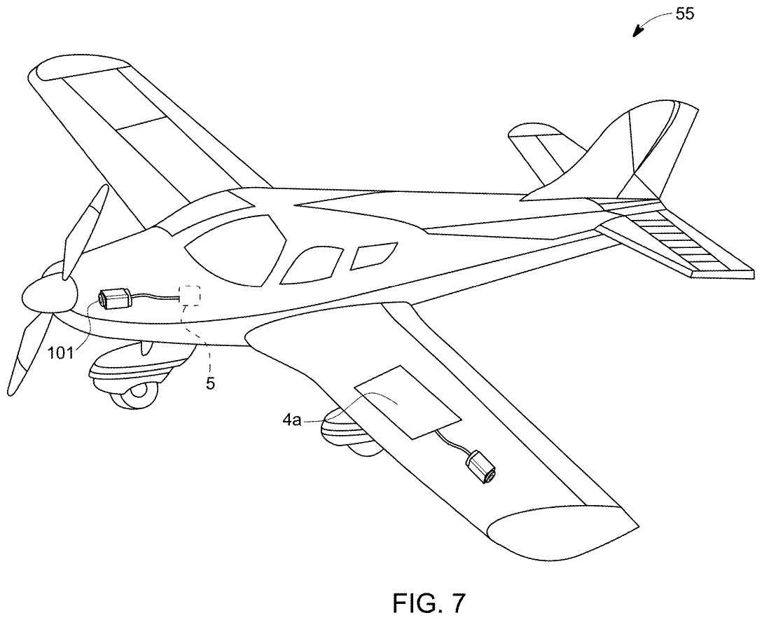

FIG. 7 is an elevated view of an electric vehicle 55 capable of flying (e.g., an airplane) according to one embodiment of present invention. This vehicle 55 may be used when an adequate stationary land base including a home or office is not affordable or available.

1. An electric vehicle, comprising:
a renewable energy source;
a battery configured to be charged by the renewable energy source;
a motor mount;
a motor coupled to the motor mount, the motor being configured to be powered by the battery; and
a body having a front portion, a plurality of side portions, a back portion, and a roof portion, wherein spacing among the portions is adjustable.

2. The electric vehicle of claim 1, wherein the renewable energy source is a solar array.

3. The electric vehicle of claim 1, wherein the renewable energy source is a wind turbo power system.

4. The electric vehicle of claim 1, wherein the renewable energy source is a charging station.

5. The electric vehicle of claim 1, wherein the renewable energy source is a hydroelectric power station.

6. The electric vehicle of claim 1, wherein the electric vehicle is a ship.

7. The electric vehicle of claim 1, wherein the electric vehicle is a train.

8. The electric vehicle of claim 1, wherein the body of the electric vehicle includes a shell having clips and
adjustable holes to enable the adjustment of spacing among interconnecting ones of the portions of the electric vehicle.

9. The electric vehicle of claim 1, wherein the electric vehicle further comprises back portion members configured to clip the portion to hole members of the body.

10. An electric vehicle, comprising:
an adjustable shell configuration including a front portion, a back portion and side portions that are separably interconnected using a plurality of clips and holes;
a renewable energy source;
a battery configured to be charged by the renewable energy source; and
a motor configured to be powered by the battery.

11. The electric vehicle of claim 10, wherein the adjustable shell further includes a roof portion interconnected with one or more of the front portion, the back portion and the side portions.

12. The electric vehicle of claim 10, wherein the renewable energy source is a solar array.

13. The electric vehicle of claim 10, wherein the renewable energy source is a wind turbo power system.

14. The electric vehicle of claim 10, wherein the renewable energy source is a charging station.

15. The electric vehicle of claim 10, wherein the renewable energy source is a hydroelectric power station.

16. The electric vehicle of claim 10, wherein the electric vehicle is a ship.

17. The electric vehicle of claim 10, wherein the electric vehicle is a train.

18. An electric vehicle, comprising:
an adjustable shell configuration including a front portion, a back portion and side portions that are separably interconnected using a plurality of clips and holes;
a renewable energy source including one or more of a solar array, a wind turbo power system or a hydroelectric power station;
a battery configured to be charged by the renewable energy source; and
a motor configured to be powered by the battery.

19. The electric vehicle of claim 18, wherein the electric vehicle is a ship.

20. The electric vehicle of claim 18, wherein the electric vehicle is a train.
